(19) United States
(12) Patent Application Publication
(10) Pub. No.: US 2009/0171728 A1
(43) Pub. Date: Jul. 2, 2009

(54) SIMULATION FRAMEWORK FOR EVALUATING DESIGNS FOR SPONSORED SEARCH MARKETS

(76) Inventors: Tak W. Yan, Palo Alto, CA (US); Prabhakar Krishnamurthy, Pleasanton, CA (US); Ketan Deshpande, San Jose, CA (US); Chih-Chao Chang, Santa Clara, CA (US); Soam Acharya, San Bruno, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(21) Appl. No.: 11/965,002

(22) Filed: Dec. 27, 2007

(51) Int. Cl. G06Q 10/00; G06F 17/30; G06Q 30/00

(52) U.S. Cl. 705/8; 707/3; 705/14; 705/30; 707/E17.014

(57) ABSTRACT

The present invention provides a method and apparatus for sponsored Internet-based search simulation. The present invention includes receiving a search query sequence that represents a search query and selecting one or more advertisements based on the search query sequence. The present invention further includes filtering the plurality of advertisements based on advertising budget data and determining a number of user-selections on the advertisements using a pre-calculated user-selection model. The present invention further includes updating advertiser account information regarding advertising rates in response to the number of user-selections and generating simulation log data reflecting the advertisings, user-selections and advertising account information. This technique thereby performs the simulation based on user search queries, in response to user-selection models and references the user-selection and advertisement with advertisement budget data, consistent with live sponsored search result operations.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to Internet-based searching operations. More specifically, embodiment of the present invention are directed towards systems, methods and computer program products for simulating sponsored search result operations including the performance of advertisements disposed therein.

### BACKGROUND OF THE INVENTION

Sponsored search is a rapidly growing business with increasing emphasis on improving the designs and functioning of sponsored search marketplaces. There exists much research interest in improving the designs and functioning of the sponsored search marketplace. Areas of exploration include: auction design, ad ranking algorithms, pricing algorithms, advertiser budget optimization, ad matching techniques, etc.

Launching new innovations require careful evaluation of different aspects of the marketplace as the scale of the marketplace is large, with users viewing millions of advertisements from hundreds of thousands of advertisers. Changes in the marketplace have large impact on the following: i) the experience of the millions of users who view and click on ads; ii) advertisers who depend on the leads generated from sponsored search (some advertisers exclusively rely on the Internet for generating leads and sales of their products and services); iii) publishers who display the ads on their web sites (some publishers are dependent on sponsored search as their main source of revenue); and iv) the marketplace operator generates substantial revenues from sponsored search. The users, advertisers and publishers all react to each others actions based on available information.

Launching new designs and enhanced features for the sponsored search marketplace requires careful evaluation of their potential consequences to user experience and financial impact on the multiple parties involved, such as advertisers, publishers and marketplace operators. The complexity of market dynamics presents difficulties in attempting to draw definitive conclusions regarding future market performance without comprehensive testing. While limited field testing is often performed, it has several disadvantages, including limited control over design parameters, as well as limited sample sizes and scenarios that can be tested. Accordingly, simulation testing is a viable option. Though some previous works have discussed the use of simulations, most of these are of an ad hoc nature and intended to only test specific scenarios.

None of the existing solutions known to those of skill in the art provide a comprehensive approach for performing realistic simulation of sponsored search marketplaces. The techniques available in the art fail to account for various real-world factors including budgetary constraints and user-selection issues that can arise from real-world user operations. Therefore, there exists a need for systems, methods and computer program products that more accurately simulate Internet-based sponsored search activities.

### SUMMARY OF THE INVENTION

Generally, the present invention provides a method and apparatus for sponsored Internet-based search simulation. The present invention includes receiving a search query sequence that represents a search query and determining one or more advertisements based on the search query sequence. The present invention further includes filtering the plurality of advertisements based on advertising budget data and determining a number of user-selections of the advertisements using a pre-calculated user-selection model. The present invention further includes updating advertiser account information regarding advertising rates in response to the number of user-selections and generating simulation log data reflecting the advertisings, user-selections and advertising account information. This technique thereby performs the simulation based on user search queries, in response to user-selection models and references the user-selection and advertisement with advertisement budget data, consistent with live sponsored search result operations.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a schematic block diagram of a system for providing Internet-based sponsored search simulation according to one embodiment of the present invention;

FIG. 2 illustrates a block diagram of a simulation device for providing Internet-based sponsored search simulation according to one embodiment of the present invention;

FIG. 3 illustrates a block diagram of a processing device and a memory device disposed within a simulation device for providing Internet-based sponsored search simulation according to one embodiment of the present invention; and

FIG. 4 illustrates a flow diagram present a method for providing Internet-based sponsored search simulation according to one embodiment of the present invention.

### DETAILED DESCRIPTION OF THE INVENTION

In the following description of the embodiments of the invention, reference is made to the accompanying drawings that form a part hereof, and in which is shown by way of illustration exemplary embodiments in which the invention may be practiced. It is to be understood that other embodiments may be utilized and structural changes may be made without departing from the scope of the present invention.

The present invention serves as a general purpose test bed for sponsored search marketplace design. This approach is comprehensive by incorporating the advertiser, user and system aspects of the marketplace, as well as a focus on methodological aspects of simulation. The system incorporates various design aspects, e.g. budget management, for instance, which address problems of data sampling and scaling the results to represent real search traffic not addressed in prior solutions. Moreover, with additional post-processing operations, the simulation operations may be further iterated and refined for greater accuracy as was as varying factors relating to the simulation itself as well as the data sets.

A simulation system in accordance with an embodiment of the present invention is operative to mimic or simulate new marketplace technologies such as: ranking and pricing; advertiser budget management; advertiser participation constraints; query to advertisement matching; and auction formats. Similarly, the simulation system allows new designs to be “plugged in” easily. Hence, embodiments provide the ability to interface with external modules that implement specific marketplace policies and features that may be included in the comparison set. Additionally, the simulation framework may be operative to execute in tandem with the external modules by exchanging data and parameters via defined interfaces.

In the repeated auction setting of sponsored search, advertisers are adaptive and respond to user behavior, marketplace changes, and to the actions of other advertisers. In fact, many advertisers are known to use automatic bid management tools which actively changing bids and budgets in response to marketplace conditions. In one embodiment, the system, as described in further detail below, simulates equilibrium conditions where advertiser behavior is non-adaptive.

From a performance standpoint, the system in accordance with one embodiment is operative to rapidly process large volumes of data. This may be necessary for both simulation preparation and execution phases. In a preparation phase relating to a simulation, actual web traffic logs may constitute a primary source of information. First, the logs are processed to extract information that may be used to train various statistical models. Next, the logs are analyzed to obtain user access data, where this data is used to drive the actual simulation. Due to the heavy volume of search traffic, this may necessitate iterating through billions of rows of log information.

In the execution phase, as described in further detail below, the system may complete a given simulation session in a timely fashion, faster than the searches in the corresponding trace. In addition, the system lends itself to automation by repeating a given simulation session multiple times without user intervention. Doing so allows the determination of the statistical significance of metrics that various scenarios generate. While some scenarios can be tested on relatively small samples of data, simulations involving advertiser budget management, query matching techniques, as well as others, may require large samples, including running multiple trials, where these scenarios run against large samples and thus require a high degree of simulator performance. Therefore, various scopes of simulations may be performed for a greater degree of search activity emulation.

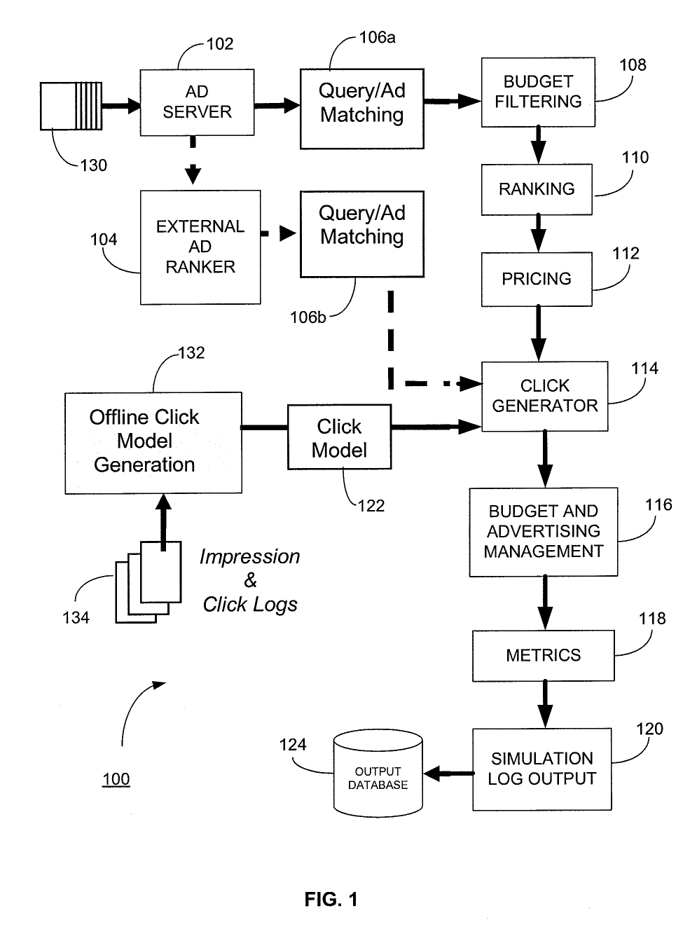

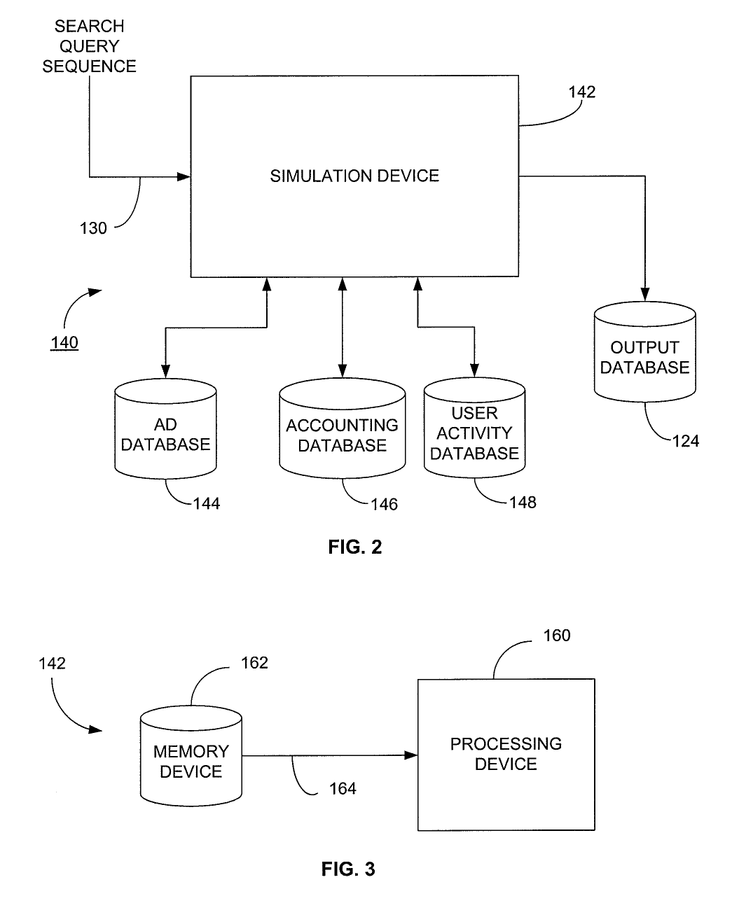

FIG. 1 illustrates one embodiment of a framework of a system 100 that allows for simulation of Internet-based searching activities. As described in further detail with respect to FIGS. 2 and 3, the elements comprising one embodiment of the system 100 may be implemented as computing modules operative to execute in one or more computing environments for performing the simulation operations.

The system 100 according to the embodiment of FIG. 1 comprises an advertisement server 102, an external ad ranker 104, first and second query/ad matching devices 106a and 106b. The system 100 includes a budget filtering module 108, a ranking module 110, a pricing module 112, a click generator module 114, a budget and advertising management module 116, a metrics module 118 and a simulation log output module 120. The system further includes a click model device 122 and an output database 124.

According to one embodiment of the system 100, search queries 130 are the primary simulation drivers. The search queries 130 represent user search queries, for example, those determined or derived by tracking actual search queries on search engine web locations. The search query is received by an ad server 102, whereupon corresponding advertisements may be retrieved. For example, one technique may be determining keywords from the search query and then retrieving corresponding advertisements associated with or having bidding rights to the keywords. The selected ads are paired with the search query, wherein the selected ads may be actual ads used in live or production advertising operations.

In one embodiment, the ads themselves may be ranked by the external ad ranking device 104, ranking the ads using any of a number of possible ranking techniques well known to those of skill in the art. For example, one technique may rank ads by business relationships between the advertiser and the search engine. In this embodiment, the ranked ads may also be processed by the query/ad matching device 106b, illustrated as element 106b to represent that this module may be in a different processing environment, such as the environment having the external ad ranker 104. Alternatively, or in conjunction with the foregoing, ads may be ranked according to the relevance of a given ad to a given query, e.g., on the basis of keyword matching between the query and the ad.

In one embodiment, the advertisement data from the ad server is provided directly to the query/ad matching device 106a, which provides candidate ads to the budget filtering device 108. The budget filtering device 108 may filter the ads on the basis of budget information associated with the advertisement sponsor. For example, the budget filtering device 108 may determine if a sponsor has enough money to cover the possible costs of the advertisements in the simulated search results. If it is determined that the budget level would not cover advertisement costs, the filtering device 108 thereby removes these advertisements from the simulation for a more accurate simulation, as the advertisements would not appear in the online search operation.

The remaining ads are then ranked by the ranking device 110 and priced by the pricing device 112. The ranking operations may be performed in a manner similar to that of the external ad ranker 104 (described above) or other suitable ranking techniques. The pricing device 112 may perform pricing calculations by cross-referencing a given ad with ad pricing information associated with the search results, the ad type, ad placement, contractual relationships between the advertisement sponsors and the search engine, as well as any other relevant pricing information. Thereupon, the click generator 114 may utilize one or more models to determine whether the current ranking of ads attracts any clicks. In one embodiment, the click generator 114 may receive ad information from the query/ad matching device 106b, where these operations may be performed, in one embodiment, by an outside device or outside processing system.

According to one embodiment, another aspect of the click generator 114 is the modeling of information relating to user click activities. The click model device 122 may provide user click modeling information to the click generator 114. This modeling information may be determined by an offline click model generation device 132 performing modeling operations on logs of user impression and user click activities 134, e.g., clicks. For example, in one embodiment, the log of user data may be based on monitoring actual user activities on one or more production search engines for one or more period of times.

While the click generator 114 determines whether the current ranking of ads generates clicks, the budget and advertising management device 116 performs bookkeeping operations on advertiser accounts that have undergone recent spending activities. For example, one billing scenario may include a “pay per click” technique, whereby the budgeting of selected click(s) is then properly managed and apportioned.

In one embodiment, the metric module 118 is operative to keep track of various summary metrics useful to a given simulation. For example, various simulations may provide for different summary metrics including tracking average revenue per search (“RPS”), average cost per click (“CPC”), average click through rate (“CTR”), a coverage amount that may be a percentage of queries where ads are shown, etc. As recognized by one skilled in the art, the metric module 118 may also track additional metrics, such as percentage of budget unspent and the complete or partial number of ads shutout. According to one embodiment, the metrics module 118 may output the metrics at the end of a given simulation.

Metric information may be received by the simulation log output device 120 that according to one embodiment is operative to output the results of a given simulation to the output database 124. The output database 124 may be one or more storage devices, either local or remote, and capable of storing the simulation information. This simulation information may thereby be used for additional system design and optimization operations as described in further detail below.

FIG. 2 illustrates one embodiment of an apparatus 140 operative to simulate Internet based searching operations similar to the system of FIG. 1. The apparatus 140 includes a simulation device 142 and is coupled to an ad database 144, an accounting database 146, a user activity database 148 and an output database 124. Databases 144, 146 and 148 may be one or more storage devices operative to store data therein and operative to provide corresponding data when requested.

The present simulation system may be run with traces derived from actual search logs, e.g. such as logs 130 and it is possible to preserve the temporal properties of user accesses for testing those time-dependent marketplace components, such as budgets.

The other aspect of user behavior incorporated into the simulation system is that of user clicks, such as the click logs 134. In one embodiment, these are based on models that predict click probability given a query, a set of ads and the type of page containing the search results. During run time, factors such as the prior success rate of the ad as well as the advertiser, the position a given advertisement appears in, etc. are combined to provide a click probability estimate for a given “page.” A random number generator may then generate synthetic clicks on the basis of these values, such as simulated in the click generator 114.

In another embodiment, the present simulation system allows a number of advertiser attributes to be modified prior to a given simulation session. In addition to specifying their budgets, advertisers may also be mapped to various categories. For example, in one embodiment this information may be stored within the accounting database 146. A proportion of advertisers within a given category may have their budgets and bids on their ads perturbed. The proportion of advertisers so affected, as well as the change in their budgets and bids, may be specified by the user via parameters to a normal distribution. Consequently, the number of advertisers chosen, as well as the degree of actual change in bids and budgets, may vary from one simulation session to another. Therefore, various simulations may be run adjusting these parameters accordingly.

These various simulations adjusted based on advertiser behavior and/or reaction provides second order assessments after adjusting first order changes. For example, an X percentage of advertisers may have their bids changed by a Y percentage, where the X percentage may be randomly chosen. Another example may include a top X percent of advertisers change their bids by Y percent, such as taking the top X percent of the advertisers by revenue and changing their bids by Y percent or a selection by tier/cluster instead of top X percent by revenue. Another example may include randomly selecting X percent of the advertisers dropping their advertisements and leaving the marketplace. Another example may include X percent of the advertisers dropping Y percent of their ads. Another example may include specific advertisers leaving the marketplace. Another example may include bulk adding X percentage of additional advertisers. Another example may include X percentage of advertisers changing their budget by Y percent. Another may include X percent of the top advertisers by revenue or by budget changing their budget by Y percent.

In one embodiment, the simulator 142 utilizes two core inputs. The first input is the query sequence 130, which is a sequence of keywords that users provide to a given search engine, which may be associated with a time stamp. Sample search sequences may be generated from historical search traffic. The second input is the bid landscape (not expressly illustrated in FIG. 2), which according to one embodiment is a mapping that associates search keywords with advertisements that have a bid on the keyword(s). The maximum bid for a given advertisement may be included in the data, with the bid landscape derived from actual ads and bids that advertisers submit to the system. Certain scenarios may utilize additional inputs. For example, an advertiser budget file, such as may be stored in the accounting database 146, is required for scenarios involving budget management and advertiser reactions to the design choices may be accepted as inputs.

The purpose of a reference simulation run, as performed by the simulation device 142, is to validate the simulation set-up, and to serve as a baseline against which the performance of other design options may be compared. The reference run, as described in further detail below, involves replicating the existing marketplace design parameters in the simulator, where these parameters are based on historical data, thereby allowing for the comparison of the outputs of the simulation against the actual historical output. In one embodiment, historical data may be stored in the user activity database 148.

The reference simulation run helps to validate a number of aspects regarding the simulation including, but not limited to, the representativeness of data inputs in terms of coverage of queries and advertisers, calibration of the user click model and calibration of the budget smoothing parameters. The click model 122 of FIG. 1 may be calibrated by estimating the click probabilities associated with a given keyword—advertisement pair from historical data. The budget smoothing parameters as used by the management device 116 may determine how forecasts of budget utilization in future time periods are generated. These forecasts may be used by the budget smoothing algorithms to provide feedback or insight into refining advertising system operations.

The system 100 may further include budget simulation operations, such as account level budgeting relating to accounts for the different advertisers. Another budgeting simulation may include campaign level budgets relating to a particular advertising campaign. The simulations may also track account level spending per simulation run and/or campaign level spending per simulation run. Another budgeting simulation may include line advertisement identifiers to campaign mappings where it can be assumed that a line advertisement belongs to one and only one campaign. In embodiments not having campaign level information, the system may assume that all ads in a single account belong to a default single campaign in that account.

Simulation operations may include comparing the results of the reference run as performed by the simulation device 142 to measurements from actual historical traffic, e.g. 130, for a number of days. Input data samples for simulation may be drawn from the same historical traffic and a t-test applied to compare simulation results with actual historical results, which are typically measured in terms of revenue per search, cost per click and overall click through rates. Other metrics may also be used depending on the design variables under evaluation. The simulation set-up for simulation operations of the device 142 is adjusted until a validated simulation setup is achieved.

The reference simulation run may be repeated for different samples of search traffic 130 (over different days), bid landscapes, and click models 122. Test runs for specific design options and scenarios are run for the same combination of search traffic samples, bid landscapes and click models as the reference run.

Additionally, the simulation may include time metrics, such as the inclusion of a system clock or other mechanism to monitor time relative to the simulation activities. A query trace may include an actual time stamp instead of a query counter. This system clock may then be updated based on time stamps seen in a trace. Additionally, a budgeting interval may be defined to update the budget constraints or matters associated with the simulation. For example, a default budget setting may be 15 minutes and budget related computations occur after every such interval.

The simulation metrics of interest may include a standard set of metrics including, but not limited to, average RPS, average CPC, average CTR, and coverage (percentage of queries where ads are shown). Other metrics may include percent of budget unspent and number of ads shutout (complete and partial).

In another embodiment, the simulation device 142 may include further filtering, such as may be performed in the budget filtering module 108 or within the accounting database 146. Filtering may be done based on a market reserve price (MRP) included in the simulation. The market reserve price filtering filters out all advertisements whose maximum bid is less then the market reserve price and is typically performed prior to ranking operations done by the ranking module 110.

Moreover, the market reserve pricing filtering is also recognized within one embodiment of the pricing module, whereby an altered pricing computation may defined to include the market reserve price as a floor value.

Furthermore, in the simulation operations that include market reserve pricing support, advertiser reaction may be further accounted for. For example, in the budget filtering module 108, all the ads that would otherwise be dropped may have their bids raised to the MRP level. In the simulation, a defined percentage may their bids raised, where this percentage can be an adjustable simulation factor, where the probability can be determined based on the difference between an original bid amount and the MRP. Another factor of MRP-based compliance may include additionally raising bid amounts for ads that were already above their MRP levels based on adjustment of bidding on related bids.

Another simulation technique may include discounting support based on a display location of the selected advertisements. It is recognized that not all advertisement placements carry the same value, therefore a discount support includes the calculation and inclusion of a discount factor for an associated display location. For example, one technique may include retrieving analytics data and traffic quality metric data associated with the website where the advertisements is selected for display and calculating a traffic quality score for the website. An adjustment factor for the website is calculated based on the traffic quality score associated with the website and a benchmark traffic quality score, such as described in copending patent application Ser. No. ______ entitled “SYSTEM AND METHOD FOR ADVERTISEMENT PRICE ADJUSTMENT UTILIZING TRAFFIC QUALITY DATA” incorporated herein by reference.

In continuation of techniques for pricing variations in simulations operations, the system 100 and/or the simulation device 142 may further include processing agents (not explicitly illustrated) related to pricing. In one embodiment, the pricing agents may be disposed within the pricing module 112. A first agent is a budget agent that computes spending information for the accounts from a fully processed click stream feed. In one embodiment, the budget agent may operate at a 30-45 minutes, which would be 2 or 3 budget intervals relative to the exemplary budget interval of 15 minutes as described above. Throttle rates are only computed for accounts with spends or clicks in the prior interval. Only accounts with a budget over a predefined amount, such as for example $50, may also be considered.

A second agent is a budget jumpstart agent, which calculates a throttle rate for all throttled (budgeted) accounts that have not received any spending in a defined time period, such as for example 3 hours. In one embodiment, a third agent may also be included, a real time calculation agent that computes up to date spending information for accounts using a real time click stream, whereby accounts may be prioritized by clicks.

In one embodiment, variations of the above-described agents may be utilized for the simulation operations of the simulation device 142. For example, one technique may be to merge the budget agent and the real time calculation agent, such as account expenditures and throttle rates are updated at the end of each budget cycle for accounts that received clicks during that cycle. Another technique may be to update the throttle rate for all throttled accounts that have had no expenditures for X number of budget intervals, where the value of X may be a user-adjustable parameter.

Within the budgetary issues and budget intervals, a throttle rate computation can also play an important role in simulation. In one embodiment, the system can compute a throttle rate for each interval based on spending and budget information on the last interval. This throttle rate information can be used at the campaign level, where the throttle rate can be set to a value of one if the campaign spending is greater then the campaign budget. In the campaign level, the throttle rate can be set based on the targeting spending level of the campaign relative to the expected spending level, where the target spending level may be the remaining budget divided by the remaining budget intervals and the expected spending level is a linear projection of spending at current spending rates. The throttle rate may also be computed at the account level using the throttling algorithms available on the campaign level.

In throttle operations, one embodiment in the simulation may include operations relating to candidate selection. For example, one embodiment may include that in candidate selection for each query, randomly selecting which candidate ads will be inspected. Upon inspection of the candidate ad, a throttling decision is then made. If the ad is dropped, it is not included in the ranking. Moreover, for each click, the simulation may add the paid bid to the campaign and account expenditure budgets.

Another factor in the performance of simulation operations are the strategies used for sampling data sets for the simulations. The system 100 may use any number of different sampling strategies. The choice of a given sampling strategy may be driven by the scenario under evaluation.

Two exemplary sampling strategies usable by the simulation device 142 are: stratified random sampling and micro-market sampling.

Stratified random sampling may be used when the independence of auction assumption is valid. This assumption states that a given auction is independent where outcomes are not influenced by the outcomes of other auctions. Thus, changing the sequence of searches according to this strategy does not affect the outcome.

One scenario that does not meet the “independence of auctions” assumption involves budget management 116. Here it is assumed that advertisers have budgets, and the amount spent should be managed to not exceed these budgets and thereby introducing interactions between queries and advertisers. The budget constraint introduces path dependence, e.g., the outcome of a series of auctions depends upon the sequence of keywords in which that advertiser participates. In such scenarios embodiments of the invention utilize the “micro-market sampling” strategy.

Stratified sampling includes independent sampling from multiple tiers or strata and is important because search queries and advertisers are heterogeneous. When there is a constraint on the sample size, stratified sampling can reduce sample variance.

While queries match to advertisements and obtaining a representative mix of queries and advertisers is important, in one embodiment, the system 100 may either sample queries or advertisers. By properly constructing advertiser tiers, the system 100 can achieve a representative sample of the marketplace in the simulation operations.

For instance, according to one embodiment, the system creates tiers of advertisers on the basis of the number of bidded keywords. Though not all keywords are equal, one technique distinguishes keywords based on the frequently in which the words appear in historical search traffic, which may be classified on the basis of the location of a keyword in the head, middle or tail portions of the frequency distribution. Advertisers may then be characterized in terms the number of bidded keywords that fall into a given portion. Thus an advertiser may be described in this dimension as large head, large middle, and small tail.

Another dimension for creating tiers may be on the basis of ad quality, the average ad quality of the advertisements for an advertiser classified as one of high, medium or low.

Still another dimension for creating tiers may be bids, with a given advertiser being classified as a high, medium or low bidder.

As the tiering technique provides improved accuracy and variances in simulation operations, other attributes for creating tiers may be used when relevant, For example, another attribute may be the mix of budgeted versus unbudgeted advertisers competing on the query. This may be employed where budget management 116 is activated in the simulation operations.

The tiering approach described in further detail below may also be extended to other facets of the marketplace in the simulation operations. For example, embodiments of the system may use tiers to scale the simulation results. After determining the tiers, a proportional number of samples from a given tier may be obtained. Independent sampling from a given tier to achieve a certain minimum sample size within a given tier (to limit the expected variation within specified bounds) may yield a tighter range of results. Although, in this situation, the sample sizes tend to be larger and the simulation therefore takes longer to run. To determine the minimum sample size within a given tier, the calculation may be based on the click probability distribution, as may be derived from the click model 122. The system may use the mean click probability of a given tier to estimate a sample size to achieve a desired bound on standard error.

One embodiment of a procedure for determining the tiers into which the system places queries or advertisers may be based on simultaneously minimizing within-tier variance and maximizing cross-tier variance. This procedure may be applied when transforming a continuous variable, such as ad quality, into a categorical one with values set to either high or low. According to one embodiment, the Fisher ratio is used as an objective function, along with constraints for minimum number of queries and revenue in a given tier. The Fisher ratio for a set of tiers is the cross-tier variance of means divided by mean of within-tier variance. The higher the Fisher ratio, the more similar are the elements within a tier and dissimilar across tiers. In the case of advertiser tiers, 3-dimensional vector (depth, average ad quality and average bid) characterizes a given query, with the dot product of two vectors as the distance between them. These data may then be used to compute a mean and variance on the dot product to determine the optimal tiers.

The stratified sampling being described above, a micro-market sampling may be, according to one embodiment, a collection of associated advertisers and keywords (advertisers bidding on the queries) such that:

ΣAi=ΣQj EQUATION 1

where Ai is the total amount spent by advertiser i, and Qj is the total revenue from query j. The total market is traffic in a period P, such that P is the period over which budgets may be replenished.

The algorithm of Equation 1 solves the so called “small boundary dense subgraph” problem. The input to this algorithm is a bi-partite graph, with one set of nodes representing advertisers (which may also comprise ads) and another set of nodes representing queries. Links between nodes in the two sets represent a “match” relationship, e.g., a search involving a query q would display ads to which it is linked. To derive a complete market of the requisite size, however, requires an estimate of the probability distribution of clicks on a given link. Using a graph where the link represent clicks aggregated over a period of time converts the problem to a deterministic one.

Accordingly, a sub-graph is generated that contains an adequate number of nodes (queries+advertisers). The sub-graph may also include a large amount of spend on the edges within the sub-graph and there is a small amount of spend on the edges connecting nodes within the sub-graph to the rest of the nodes (relative to the amount of spend on the edges within the sub-graph).

There are parameters that control the relative importance of these different concerns. The algorithm produces solutions for a given set of parameter settings. A micro-market according to the present embodiment is typically not representative; for example the distribution of tiers of advertisers or queries in the sample may not be proportional to the distributions in historical traffic. Accordingly, the results are scaled to obtain results that pertain to traffic for a given day.

The stratification scheme described above may be used for scaling purposes, which may utilize the above-described stratification scheme for advertisers or for queries, depending upon the metrics to be evaluated. Scaling is based on the idea that the queries or advertisers within a given tier are fungible. In scaling, the objective is to extrapolate results obtained for the sample to an actual day's traffic. Revenue and clicks in a given tier may therefore be scaled as follows:

rscaled(i)=rsim(i)*n(i)/nsamp(i) EQUATION 2

where rsim(i) is the spend in tier i from the simulation, n(i) is the number of queries (or advertisers) in the traffic to which we are trying to scale, and nsamp(i) is the number of queries (or advertisers) in the sample used as input for the simulation. Similarly, for clicks:

cscaled(i)=csim(i)*n(i)/nsamp(i) EQUATION 3

The revenue and number of clicks is added across the tiers to obtain the total number of searches and the coverage from the actual traffic. Thereby, these different scalings are available for the simulation device 142 to perform varying simulation operations and better analyze the search results and associated advertisement revenue associated therewith.

In one embodiment, FIG. 3 illustrates a processing device 160 and a memory device 162 disposed within the simulation device 142 of FIG. 2. The memory device 162 has executable instructions 164 stored therein. The processing device 160 may be one or more processing elements operative to perform processing operations in response to the executable instructions received from the memory device 162. Similarly, the memory device 162 may be one or more memory devices capable of having executable instructions stored therein. While illustrated generally in FIG. 3, it is recognized that distributed computing operations may provide for various sets of executable instructions 164 provided to various processing devices 160 from various memory devices 162 such that the combination of processing operations perform the underlying functionality described and disclosed herein.

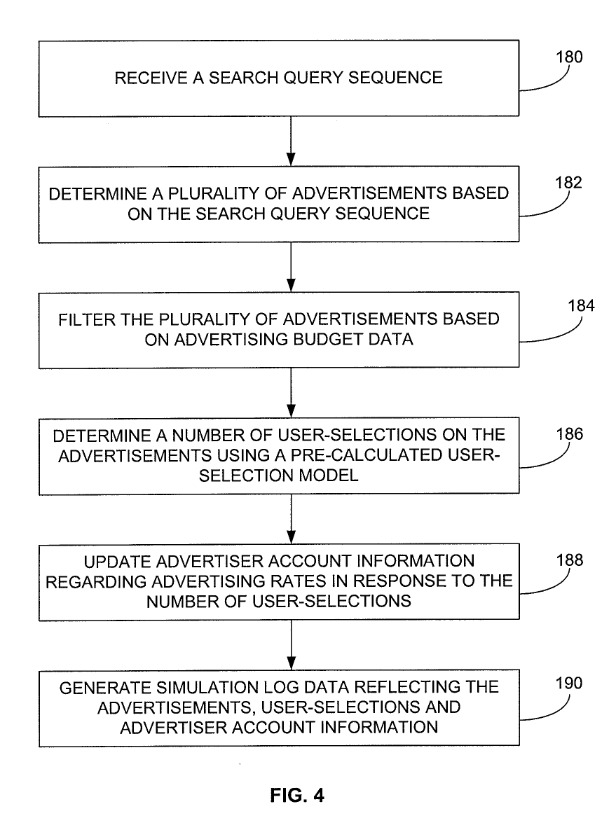

FIG. 4 illustrates one embodiment of a method for sponsored Internet-based search simulation. These steps may be performed by the simulation device performing processing steps on a processing device in response to the executable instructions received from a memory device. In accordance with the embodiment of FIG. 4, a first processing step, step 180, is to receive a sequence of one or more search queries. For example, the simulation device may receive the search query. A next step, step 182, is to select or determine one or more advertisements on the basis of the search query sequence. This selection or determination may be performed by accessing the ad database 144, which is operative to maintain advertisement information.

A next step, step 184, may filter the plurality of advertisements on the basis of the advertising budget data. This step may be performed on the basis of the advertising data from an advertising database, as well as accounting or budget information from an accounting database. A next step, step 186, may determine a number of user-selections on the advertisements using a user-selection model, which according to one embodiment is a pre-calculated user-selection model. As described above, this may be accomplished using one or more user-selection models, where user activity or modeling information may be stored in a user activity database.

A next step, step 188, may update advertiser account information regarding advertising rates in response to the number of user-selections. A processing device may perform this operation, which may be performed internally, or in another embodiment may be performed by data interaction with the accounting database. Thus, in this embodiment, a final step, step 190, may generate simulation log data that reflects the advertisements, user-selections and advertiser account information. Similar to the embodiment described above relative to FIG. 1, this information may be processed for metric information and output for storage in an output database.

In another embodiment, not expressly illustrated in FIG. 4, the methodology may iteratively repeat, with one or more data sets for one or more different variables or market conditions. Accordingly, the methodology may include determining a second plurality of advertisements, filtering the second plurality of advertisements, determining a second number of user-selections using a second pre-calculated user-selection module and generating second simulation log data in response thereto.

The system thereby may provide for the performance of simulating sponsored Internet-based searching activities. These simulations account for various real-world factors to more accurately reflect the actual activities performed by the search engine, including accounting for various levels of contingent information, such as the budgetary information associated with advertisement costs. From this, a more accurate scope of data is made available for post-processing activities in the development and refinement of advertising engines, as well as in the optimization of sales aspects related to determining which entities can or should conduct advertising operations.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms memory and/or storage device may be used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for sponsored Internet-based search simulation, the method comprising:
receiving a plurality of search query sequences;
in response to each of the search query sequences:
selecting a plurality of advertisements;
filtering the plurality of advertisements based on advertising budget data;
determining a number of user-selections on the advertisements using a pre-calculated user-selection model;
updating advertiser account information regarding advertising rates in response to the number of user-selections; and
generating simulation log data reflecting the advertisements, user-selections and advertiser account information for the search query sequences.

2. The method of claim 1, wherein at least one of the plurality of search query sequences is derived from an existing set of search traffic data

3. The method of claim 1 further comprising:
extrapolating a plurality of design choices associated with the simulation, wherein queries of the search query sequences and advertiser information is based on a micro-market sampling.

4. The method of claim 1, wherein the advertising rates include discounting support based on a display location of the selected advertisements.

5. The method of claim 1 further comprising:
after filtering the plurality advertisements, ranking and pricing the filtered plurality of advertisements.

6. The method of claim 1 further comprising:
tracking a plurality summary metrics in conjunction with the simulation log generation, wherein the summary metrics include at least one of: average revenue per search (RPS) data, an average cost per click (CPC) data, an average click through rate (CTR) data, and an advertisement coverage data.

7. The method of claim 1, wherein the step of filtering the plurality of advertisements based on advertising budget data further includes filtering based on a market reserve price.

8. The method of claim 7, wherein the filtering includes at least one of: excluding all advertisements having a maximum bid less then the market reserve price; and raising a bid amount on all advertisements that would be otherwise excluded for having a bid less than the market reserve price, and wherein the filtering based on the market reserve pricing technique is conducted prior to a ranking of the advertisements.

9. The method of claim 1 further comprising:
adjusting a simulation parameter;
generating second simulation log data based on the adjusted parameter; and
comparing the simulation log data and second simulation log data to assess a first order impact of the adjustment.

10. The method of claim 9 wherein the simulation log parameter includes at least one of new ranking information, advertisement pricing information, advertisement matching information, and budget management information.

11. The method of claim 9 further comprising:
adjusting an advertiser behavior factor;
generating third simulation log data based on the adjusted advertiser behavior factor; and
comparing the third simulation log data with the second simulation log data to assess a second order impact of the adjustment

12. The method of claim 1 wherein the advertising budget data is determined based on at least one of: an account level and a campaign level.

13. Computer readable media comprising program code that when executed by a programmable processor causes the processor to execute a method for sponsored Internet-based search simulation, the computer readable media comprising:
program code for receiving a plurality of search query sequences;
program code for selecting a plurality of advertisements based on the search query sequences;
program code for filtering the plurality of advertisements based on advertising budget data;
program code for determining a number of user-selections on the advertisements using a pre-calculated user-selection model;
program code for updating advertiser account information regarding advertising rates in response to the number of user-selections; and
program code for generating simulation log data reflecting the advertisements, user-selections and advertiser account information for the search query sequences.

14. The computer readable media of claim 13 further comprising:
program code for extrapolating a plurality of design choices associated with the simulation, wherein queries of the search query sequences and advertiser information is based on a micro-market sampling.

15. The computer readable media of claim 13, wherein the advertising rates include discounting support based on a display location of the selected advertisements.

16. The computer readable media of claim 13 further comprising:
program code for tracking a plurality summary metrics in conjunction with the simulation log generation, wherein the summary metrics includes at least one of: an average revenue per search (RPS) data, an average cost per click (CPC) data, an average click through rate (CTR) data, and an advertisement coverage data.

17. The computer readable media of claim 13, wherein the program code for filtering the plurality of advertisements based on advertising budget data further includes program code for filtering based on a market reserve price, wherein the filtering includes at least one of: excluding all advertisements having a maximum bid less then the market reserve price; and the filtering includes raising a bid amount on all advertisements that would be otherwise excluded for having a bid less than the market reserve price, and wherein the filtering based on the market reserve pricing technique is conducted prior to a ranking of the advertisements.

18. The computer readable media of claim 13 further comprising:
program code for adjusting a simulation parameter;
program code for generating second simulation log data based on the adjusted parameter; and
program code for comparing the simulation log data and second simulation log data to assess a first order impact of the adjustment, wherein the simulation log parameter includes at least one of new ranking information, advertisement pricing information, advertisement matching information, and budget management information.

19. The computer readable media of claim 13 further comprising:
program code for adjusting an advertiser behavior factor; and
program code for generating third simulation log data based on the adjusted advertiser behavior factor; and
program code for comparing the third simulation log data with the second simulation log data to assess a second order impact of the adjustment.

20. An apparatus for sponsored Internet-based search simulation, the apparatus comprising:
a memory device having executable instructions stored therein; and
a processing device, in response to the executable instructions, operative to:
receive a plurality of search query sequences;
in response to each of the search query sequences:
select a plurality of advertisements based on the search query sequences;
filter the plurality of advertisements based on advertising budget data;
determine a number of user-selections on the advertisements using a pre-calculated user-selection model;
update advertiser account information regarding advertising rates in response to the number of user-selections; and
generate simulation log data reflecting the advertisements, user-selections and advertiser account information for the search query sequences.

21. The apparatus of claim 20, the processing device, in response to the executable instructions, further operative to:
extrapolate a plurality of design choices associated with the simulation, wherein queries of the search query sequences and advertiser information is based on a micro-market sampling.

22. The apparatus of claim 20, wherein the advertising rates include discounting support based on a display location of the selected advertisements.

23. The apparatus of claim 20, the processing device, in response to executable instructions, further operative to:
track a plurality summary metrics in conjunction with the simulation log generation, wherein the summary metrics includes at least one of: average revenue per search (RPS) data, an average cost per click (CPC) data, an average click through rate (CTR) data, and an advertisement coverage data.

24. The apparatus of claim 20, wherein the filtering the plurality of advertisements based on advertising budget data further includes filtering based on a market reserve price, wherein the filtering includes at least one of: excluding all advertisements having a maximum bid less then the market reserve price; and the filtering includes raising a bid amount on all advertisements that would be otherwise excluded for having a bid less than the market reserve price, and wherein the filtering based on the market reserve pricing technique is conducted prior to a ranking of the advertisements.

25. The apparatus of claim 20, wherein the processing device, in response to executable instructions, is further operative to:
adjust simulation parameters;
generate second simulation log data and third simulation log data based on the adjusted parameters;
compare the simulation log data and second simulation log data to assess a first order impact of the adjustment; and
compare the third simulation log data with the second simulation log data to assess a second order impact of the adjustment.
